(19) United States
(12) Patent Application Publication
(10) Pub. No.: US 2026/0171861 A1
(43) Pub. Date: Jun. 18, 2026

(54) METHOD FOR AFFIXING THE TEETH OF A STATOR TO A CASING

(71) Applicant: AMPERE S.A.S., Boulogne Billancourt (FR)

(72) Inventors: Damien BIROLLEAU, Guyancourt Cedex (FR); Olivier FAYE, Guyancourt Cedex (FR); Ferdinand FRABOLOT, Guyancourt Cedex (FR); Valentin FRADET, Guyancourt Cedex (FR); Benoit MEUNIER, Guyancourt Cedex (FR)

(73) Assignee: AMPERE S.A.S., Boulogne Billancourt (FR)

(21) Appl. No.: 19/126,359

(22) PCT Filed: Oct. 26, 2023
(86) PCT No.: PCT/EP2023/080010

§ 371 Date: May 1, 2025

(30) Foreign Application Priority Data
Nov. 3, 2022 (FR) FR2211424

(51) Int. Cl. H02K 3/28; H02K 1/14; H02K 21/24

(52) U.S. Cl. CPC H02K 3/28; H02K 1/148; H02K 21/24

(57) ABSTRACT

An element of an electric machine having a planar fixture surface is intended to be affixed by gluing to a planar fixture surface of another element of an electric machine. The element includes at least two ribs arranged to project from the planar fixture surface and being, along the entire length thereof, the same height measured perpendicularly to the planar fixture surface

The invention relates to an architecture of stator teeth or of a casing in an axial-flux rotary electric machine, in particular of the permanent-magnet type, with a view to assembling them.

As is known per se, rotary electric machines have a stator, which is secured to a casing, and a rotor, which is secured to a shaft. The rotor may be secured to a driveshaft and/or driven shaft and may belong to a rotary electric machine in the form of an alternator or of an electric motor. The casing is configured to rotatably support the shaft of the rotor, for example by means of rolling bearings.

The rotor is provided with poles formed, for example, by permanent magnets, while the stator has phase windings, which are typically made up of coils that are closed in on themselves and are wound around teeth.

In axial-flux electric machines, the stator and rotor are arranged such that the electromagnetic flux flows parallel to the shaft of the rotor. The majority of axial-flux electric machines comprise a plurality of stators and/or rotors each having a disk shape, these elements being separated, along the axial direction of the shaft of the rotor, by interspaces referred to as air gaps.

In certain configurations, two stators are arranged one on each side of a rotor along the axial direction of the shaft of the rotor. Each stator can then be solely composed of teeth and of their windings, which are attached to the casing. The invention relates more particularly to this type of configurations.

The assembly of the teeth of the stator on the casing significantly influences the performance of the electric machine. Specifically this assembly makes it possible to control the air gap between the stator and the rotor. The air gap satisfies in particular very precise distance limitations so that the magnetic field formed by the stator can drive the rotor in motor mode. Furthermore, the assembly has to withstand the stresses to which the electric machine is subjected (vibrations, temperature, etc.).

Moreover, this assembly also influences the cooling of the member that is performed, in certain configurations, by cooling circuits arranged on the outer faces of the casings.

There are several solutions for assembling the teeth of the stator to the casing, a first solution being assembly by screw-fastening. However, this solution involves the addition of material and can require the shape of the cooling circuit to be modified in order to be implemented.

A second solution consists in adhesively bonding the teeth of the stator to the casing. However, using adhesive between two planar surfaces can cause a number of problems. Specifically, if the quantity of adhesive is not uniform, the tooth will then be incorrectly positioned on the casing and the air gap would then not be controlled. Moreover, air bubbles can be created during assembly, which would result in a reduction in the adhesive-bonding surface area and therefore in the strength of the tooth as well as a reduction in the efficiency of the cooling circuit since the heat exchange would be less optimal.

There is therefore a need for a tooth or casing to the casing while at the same time maintaining a constant air gap and avoiding the creation of air bubbles.

To this end, the present invention proposes an electric machine element that has a planar assembly face intended to be assembled by adhesive bonding to a planar assembly face of another element of an electric machine. Said element comprises at least two ribs arranged so as to protrude from its planar assembly face and having, over their entire length, the same height measured perpendicular to said planar assembly face.

Using the technique of adhesively bonding two electric machine elements has the advantage of attaching them without adding components. Moreover, the presence of ribs makes it possible to ensure a sufficient reserve of adhesive while at the same time minimizing air bubbles in order to ensure complete and optimal adhesive bonding of the two elements. Furthermore, since the ribs are all the same height, they make it possible to maintain an identical spacing between the two assembled elements after adhesive bonding. The reserve of adhesive is determined by the height of the ribs, which can preferably be from 0.2 millimeters to 0.8 millimeters. The proposed solution is also easy to implement industrially, in particular when the ribs are produced by punching.

Advantageously and non-limitingly, the assembly face may be defined by a plurality of edges and the at least two ribs may extend from one edge to another edge of the assembly face.

One advantage is to be able to control the quantity of adhesive reserved over a larger surface area since the at least two ribs extend from one edge to another of the

Advantageously and non-limitingly, one rib may be arranged along an edge of the assembly face and the at least one other rib may be arranged along an edge on the opposite side of the assembly face.

Another advantage is controlling a larger surface area for the quantity of adhesive that is enclosed by the at least two ribs and making it easier to produce the element, in particular when it is a stator tooth.

Advantageously and non-limitingly, the at least two ribs may be parallel to one another.

Advantageously and non-limitingly, the at least two ribs may have a cross section with an identical shape over their entire length.

This can enable the adhesive to be spread identically along the edges of the ribs. It should be noted that the ribs may have a cross section with an identical shape but variable dimensions over their length. This can enable, for example, facing edges of the ribs to be held parallel to one another. Alternatively, the ribs may have a cross section with an identical shape and dimensions over their entire length.

In general, it may be more straightforward to produce identical ribs.

Advantageously and non-limitingly, each rib may have at least one of the following features:
a cross section in the shape of a quadrilateral, optionally in the shape of a trapezium, a first side of which is secured to the assembly face and at least the corners of which between a second side on the opposite side to the first side and lateral sides connecting them are rounded,
a symmetrical cross section with respect to a median longitudinal plane perpendicular to the assembly face.

A cross section in the shape of a quadrilateral, at least two corners, or even all the corners, of which are rounded enables the adhesive present between the top of the rib and the assembly face of the other element to be removed from the sides of each rib when the two elements are pressurized in order carry out the adhesive bonding and to thus ensure direct contact without a layer of adhesive between the top of the rib and the assembly face of the other electric machine element.

This removal can be promoted by a cross section in the shape of a trapezium, the large base of which is secured to the assembly face and at least the corners of which between the small base and the lateral sides are rounded. The symmetry of the cross section, for its part, ensures that the adhesive is spread identically on each side of a rib.

Advantageously and non-limitingly, the electric machine element may be selected from among a stator tooth and a casing.

Another object of the invention is a member of a rotary electric machine, in particular an axial-flux electric machine, comprising a plurality of first elements each defining a stator tooth and a second element defining a casing. Each first element having a planar assembly face assembled using a layer of adhesive to a planar assembly face of the second element, and each of the first elements or the second element is an element as described above. At least two ribs thus extend between the assembly face of each first element and the assembly face of the second element, and the layer of adhesive extends from an assembly face of each first element to the assembly face of the second element, each rib of the assembly face of one element being in direct contact with the assembly face of the element facing it.

Direct contact is understood to mean that there is no adhesive between the rib and the assembly face of the element facing it in their contact region.

Advantageously and non-limitingly, each first element defining a stator tooth may be formed from a stack of laminations along a stacking direction, each lamination extending perpendicular to the assembly face of the casing. The at least two ribs may thus advantageously extend parallel to a stacking direction of the laminations.

The invention also relates to a rotary electric machine, in particular an axial-flux rotary electric machine, comprising a rotor having a rotor disk and a shaft, and two members as described above, wherein the rotor disk is secured for conjoint rotation with the shaft and the two members are mounted one on each side of the rotor disk, the assembly face of the casing of each member being directed toward the rotor disk and the casing of each member being mounted on the shaft via rolling bearings, the two casings being assembled to one another.

The invention may in particular relate to a motor vehicle fitted with the rotary electric machine described above.

Other particular features and advantages of the invention will become apparent upon reading the description given below of several particular embodiments of the invention, which are given by way of indication but are non-limiting, with reference to the appended drawings, in which:

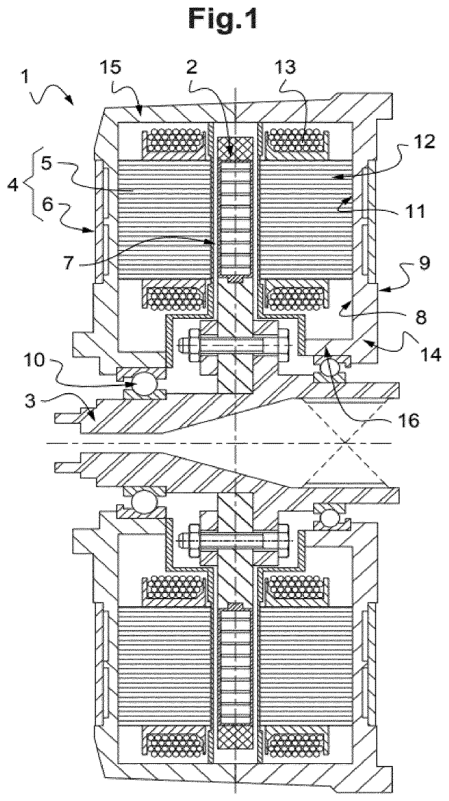

FIG. 1 is a sectional view of an axial-flux rotary electric machine.

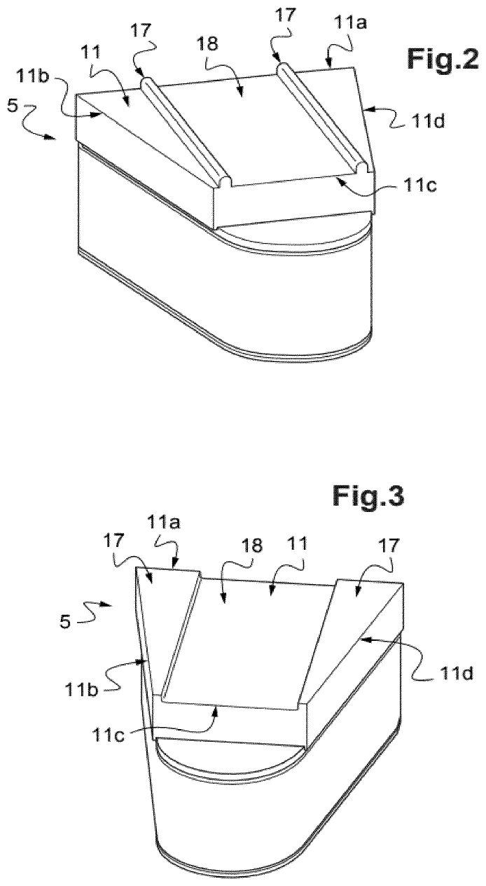

FIG. 2 is a perspective view of a stator tooth according to one implementation of the invention.

FIG. 3 is a perspective view of a stator tooth according to another implementation of the invention.

FIG. 4 is a sectional view of a member of a rotary electric machine according to one implementation of the invention.

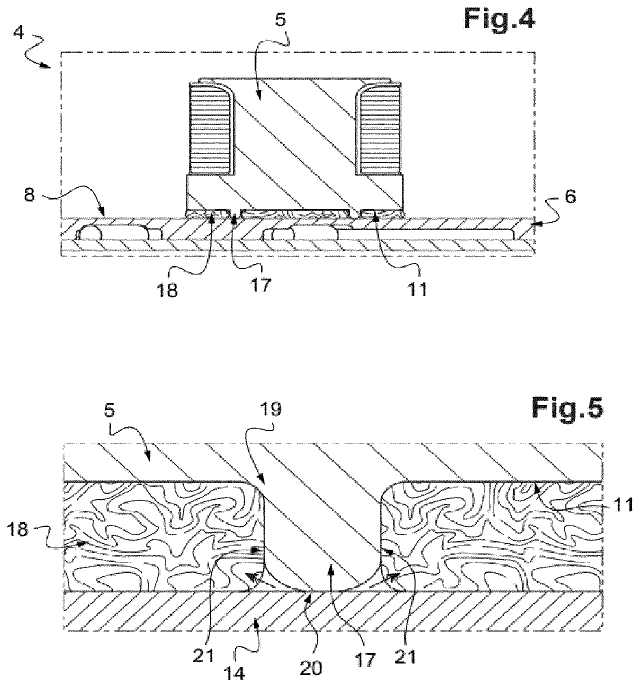

FIG. 5 is a sectional view of a rib of a member of a rotary electric machine according to one implementation of the invention.

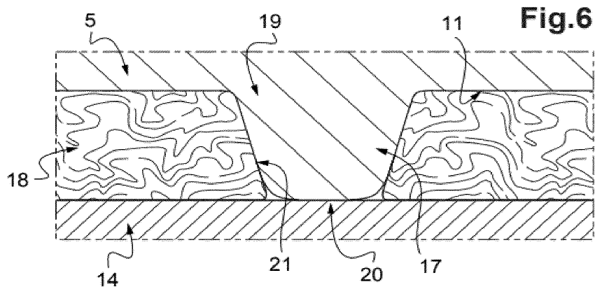

FIG. 6 is a sectional view of a rib of a member of a rotary electric machine according to another implementation of the invention.

The invention relates to an axial-flux rotary electric machine 1 in a motor vehicle.

With reference to FIG. 1, the axial-flux rotary electric machine 1 comprises a rotor comprising a rotor disk 2 secured for conjoint rotation with an output shaft 3. The axis of rotation of this shaft 3 extends perpendicular to the rotor disk 2 and passes through the center of the latter. On each side of the rotor disk 2, the electric machine 1 also comprises a member 4 comprising a plurality of first elements each defining a stator tooth 5 assembled to a second element defining a casing 6. This member 4 is separated from the rotor disk 2 by a predetermined fixed distance referred to as an air gap 7.

The two members 4 are similar and have the same elements. For the sake of clarity, in FIG. 1, the elements of just one of the members have been designated by reference signs and in the remainder of the description, just one of the members 4 is described in detail, the structure of the other member 4 being identical or similar.

The metallic casing 6 of the member 4 has an inner face 8 and an outer face 9 on the opposite side to the inner face 8. These faces 8, 9 are the faces of a wall 14 of the casing. The casing may be composed of any metal or alloy conventionally used for manufacturing casings, such as aluminum, for example. The casing 6 is also mounted on the shaft 3 via rolling bearings 10.

The casing 6 has a half-shell shape thus covering the stator 5 and the rotor disk 2 partially. It thus has a substantially planar wall 14 that defines the inner 8 and outer 9 faces and extends parallel to the rotor disk 2, this wall 14 being equipped with an outer lateral wall 15 forming a face dedicated to coupling with the other casing and an inner lateral wall 16 having a rolling bearing housing. The two casings of the members 4 situated one on each side of the rotor disk 2 are thus assembled to one another by their outer lateral walls 15. The inner face 8, also referred to as planar assembly face 8, is thus defined (delimited) by a plurality of edges. This planar assembly face 8 of each casing thus faces a face of the rotor disk 2. The rolling bearings 10 are received in rolling bearing housings of the inner lateral walls 16 of the members 4 and corresponding housings of the shaft 3.

The teeth 5 of the stator are in this case arranged so as to form a disk, or more specifically a ring, the center of which defines a cylindrical passage for the shaft 3. Said teeth are therefore placed radially with respect to this cylindrical passage and equidistantly therefrom.

The teeth 5 are typically manufactured from a stack of metallic laminations 12, each lamination extending perpendicular to the inner face 8 of the casing 6 after assembly. The metallic laminations 12 may be formed from any metal or alloy conventionally used for stators such as an alloy composed of steel and silicon, for example. The teeth 5 of the stator are surrounded by metallic wires 13 thus forming the coil. The metallic wires 13 may be manufactured with metals or alloys suitable for forming a coil, such as copper, for example.

The teeth 5 of the stator also comprise a planar assembly face 11 defined (delimited) by a plurality of edges and intended to be secured by adhesive bonding to the inner face 8 of the casing 6, which is also a planar assembly face 8. In the example shown, the planar assembly face 11 is in the shape of a quadrilateral, in this case a trapezium, and is thus delimited by four edges 11a, 11b, 11c, 11d. The invention is not, however, limited to one planar assembly face shape. The latter depends in particular on the type of tooth used.

According to the invention, the teeth 5 of a member 4 are assembled to the associated casing 6 using adhesive.

The adhesive used is typically an epoxy or two-component adhesive.

In order to optimize the adhesive bonding of these elements, at least two ribs 17 are arranged so as to protrude from one of the planar assembly faces 8, 11. These ribs 17 thus make it possible to separate the planar assembly faces, forming a free space that can be filled with adhesive. Preferably, there are two ribs, but more may be envisioned depending on the architecture of the element to be adhesively bonded.

These ribs 17 extend from the assembly face of the element to which they are secured to the assembly face of the other element. Thus, when the elements 5 and 6 of the member 4 are assembled, the tops of the ribs are in contact with an assembly face. The ribs 17 have, over their entire length, the same height measured perpendicular to the assembly face to which they are secured. They are thus arranged so as to create one or more free spaces each forming a reserve 18 of adhesive of the same height as them. These reserves are formed between the ribs and/or between the ribs and the edges of the assembly face. The height of the ribs 17 may thus be selected on the basis of the quantity of adhesive to be applied for optimal assembly, it is typically selected to be between 0.2 mm and 0. 8 mm and preferably between 0. 4 and 0. 6 mm (limits included), for example 0.5 mm. The reserves 18 of adhesive make it possible to ensure complete adhesive bonding of the tooth on the casing as well as to reduce the risk of air bubbles being created since the space formed between the two assembly faces makes it possible to eliminate air bubbles when the adhesive is applied. Moreover, since the quantity of air bubbles likely to form is reduced, the heat exchange between the stator teeth 5 and the casing 6 is optimized. The ribs 17 may be arranged either on each assembly face 11 of the plurality of first elements each defining a tooth 5 or on the assembly face 8 of the casing 6. Preferably, the ribs 17 are arranged on each of the teeth 5 of the stator as shown in FIGS. 2 to 4.

The ribs 17 themselves are typically made up of the same material as that used to form the assembly face of the teeth or the assembly face of the casing. Thus, they may, for example, be made up of sheet metal. When they are produced on a tooth, the ribs may be manufactured by punching.

FIG. 2 shows a stator tooth 5, the assembly face 11 of which has two protruding ribs 17, the tooth 5 being intended to be assembled to the assembly face 8 of the casing 6, as shown in FIG. 4. In this embodiment, the ribs are parallel and extend from one edge 11c of the assembly face 11 to the edge 11a on the opposite side, at a distance from the other edges, this making it possible to define three reserves of adhesive 18. These ribs 17 are identical and in this case have a section with an identical shape and dimensions over their entire However, the configuration of the ribs is not limited to this example. The ribs 17 may extend from one edge of one of the assembly faces 8, 11 to another edge of one of these assembly faces 8, 11. Thus, the ribs 17 do not necessarily extend between two edges on opposite sides and may therefore connect two other edges, in particular contiguous edges.

With reference to FIG. 3, the two ribs 17 are arranged along two edges 11b, 11d on opposite sides of the assembly face. However, the arrangement of the ribs 17 is not limited to this example. Just one of the ribs may be arranged along an edge, for example. In this example, the ribs 17 have a cross section with an identical shape along their entire length but the dimensions of which increase progressively from one edge 11c of the assembly face to the other edge 11a. The ribs 17 are in this case identical but arranged symmetrical one on each side of the tooth. In this embodiment, a single reserve of adhesive 18 is thus formed between the ribs, this reserve of adhesive having a rectangular shape in this case. The invention is of course not limited to a specific shape of the reserve of adhesive, the important point being that the height of the reserve of adhesive is constant. The ribs 17 preferably extend parallel to the stacking direction of the laminations as shown in FIGS. 2 and 3.

With reference to FIG. 5, the cross section of the ribs 17 may have a rectangular shape, one side 19 of which is secured to the assembly face 11. The ribs 17 also have rounded corners between the side 20 on the opposite side to the side 19 and the lateral sides 21.

However, the cross section of the ribs 17 is not limited to this shape. More generally, the cross section may be in the shape of a quadrilateral, a first side 19 of which is secured to the assembly face 11 and the corners of which between a second side 20 on the opposite side to the first side 19 and the lateral sides 21 are rounded. Preferably, with reference to FIG. 6, the cross section of the ribs 17 may have a trapezoidal shape, a first side 19 of which, forming the large base, is secured to the assembly face 11. The ribs 17 also have rounded corners between a second side 20, forming the small base, on the opposite side to the large base 19 and the lateral sides 21.

The rounded corners make it possible to force out the adhesive between the small base 20 and the assembly face 8 facing it in order to thus enable direct contact between these two surfaces. This makes it possible to control the adhesive bonding of the two assembly faces 8, 11 to one another and thus to control the distance of the air gap 7 between the teeth 5 of the stator and the rotor 2.

Finally, in order to control this distance and to enable an equal distribution of the adhesive between and/or around the ribs 17, the latter preferably have a symmetrical cross section with respect to a median longitudinal plane perpendicular to the assembly face 8, 11 to which they are secured.

In general, the teeth may be assembled to the casing by depositing the adhesive onto the assembly face that does not have the ribs. Then, by placing the two assembly faces 8 and 11 together. In this step, it is possible to press against the element having the ribs for a long time until the adhesive is distributed into the reserves 18 and takes effect. By pressing against the element having the ribs, the adhesive present on the second side 20 of the rib will be expelled from this part toward the lateral edges of the ribs. In particular, rounded corners make it possible to promote the expulsion of the adhesive that will flow more efficiently and more rapidly than if the corners were right angles, thus also promoting the removal of any air bubbles present.

In the embodiments described with reference to the figures, the ribs are secured to the assembly face of the stator teeth. In a variant, these ribs may be produced so as to protrude from the assembly face 8 of the casing, for example by a casting process or by machining. Provision may thus be made for equipping the assembly face 8 of the casing with a plurality of groups of at least two ribs. There are thus as many groups of ribs as there are teeth to be attached to the casing and the groups are positioned so as to correspond to the locations of the stator teeth to be attached to the casing.

If the ribs are arranged on the assembly face 8 of the casing, it is not necessary for them to extend over the entire length of the casing. They may nevertheless advantageously extend from one edge to another of the assembly face 11 of the tooth 5 facing it.

Thus, regardless of whether the ribs are provided on the assembly face of each tooth or on the assembly face of the casing, at least two ribs extend between the assembly face of each stator tooth and the assembly face of the casing, thus making it possible to spread a layer of adhesive between these assembly faces, the ribs (their top) being in close contact with an assembly face.

The invention has been described with reference to an axial-flux rotary electric machine having a rotor and two stators. It may nevertheless be applied to the assembly of stator teeth to a casing or to another element for supporting teeth of an axial-flux rotary electric machine with a different structure or even of a radial-flux rotary electric machine.

1-10. (canceled)

11. An electric machine element that has a planar assembly face configured to be assembled by adhesive bonding to a planar assembly face of another element of an electric machine,
said element comprising at least two ribs arranged so as to protrude from the planar assembly face of the element and having, over their entire length, a same height measured perpendicular to said planar assembly face of the element.

12. The electric machine element as claimed in claim 11, wherein the assembly face of the element is defined by a plurality of edges and the at least two ribs extend from one edge to another edge of the assembly face of the element.

13. The electric machine element as claimed in claim 11, wherein a first rib of the at least two ribs is arranged along an edge of the assembly face of the element and a second rib of the at least two ribs is arranged along an edge on the opposite side of the assembly face of the element.

14. The electric machine element as claimed in claim 11, wherein the at least two ribs are parallel to one another.

15. The electric machine element as claimed in claim 11, wherein the at least two ribs have a cross section with an identical shape over their entire length.

16. The electric machine element as claimed in claim 11, wherein each rib of the at least two ribs has at least one of the following features:
a cross section in a shape of a quadrilateral, a first side of which is secured to the assembly face of the element and corners of which between a second side on the opposite side to the first side and lateral sides connecting them are rounded,
a symmetrical cross section with respect to a median longitudinal plane perpendicular to the assembly face of the element.

17. The electric machine element as claimed in claim 16, wherein the quadrilateral is a trapezium.

18. The electric machine element as claimed in claim 11, wherein the electric machine element is selected from among a stator tooth and a casing.

19. A member of a rotary electric machine, comprising:
a plurality of first elements each defining a stator tooth and a second element defining a casing, each first element having a planar assembly face assembled using a layer of adhesive to a planar assembly face of the second element,
wherein each of the first elements or the second element is the electric machine element as claimed in claim 11,
wherein the at least two ribs extend between the assembly face of each first element and the assembly face of the second element, and
wherein the layer of adhesive extends from the assembly face of each first element to the assembly face of the second element, each rib of the assembly face of one element being in direct contact with the assembly face of the element facing it.

20. The member as claimed in claim 19, wherein the rotary electric machine is an axial-flux electric machine.

21. The member as claimed in claim 19, wherein each first element defining a stator tooth is formed from a stack of laminations along a stacking direction, each lamination extending perpendicular to the assembly face of the casing,
wherein the at least two ribs extend parallel to a stacking direction of the laminations.

22. A rotary electric machine, comprising:
a rotor having a rotor disk and a shaft, and
two of the members as claimed in claim 19,
wherein the rotor disk is secured for conjoint rotation with the shaft and the two members are mounted one on each side of the rotor disk, the assembly face of the casing of each member being directed toward the rotor disk and the casing of each member being mounted on the shaft via rolling bearings, the two casings being assembled to one another.

23. The rotary electric as claimed in claim 22, wherein the rotary electric machine is an axial-flux electric machine.
